(19) United States
(12) Patent Application Publication
(10) Pub. No.: US 2007/0134570 A1
(43) Pub. Date: Jun. 14, 2007

(54) Long life photoconductors

(75) Inventors: James Alan Hartman, Broomfield, CO (US); Laura Lee Kierstein, Longmont, CO (US); Dat Quoc Nguyen, Platteville, CO (US); Ronald Harold Levin, Lafayette, CO (US); Weimei Luo-Gheleta, Louisville, CO (US); Tanya Yvonne Thames, Aurora, CO (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/300,065

(22) Filed: Dec. 14, 2005

(51) Int. Cl. G03G 5/047

(52) U.S. Cl. 430/58.45; 430/59.6

(57) ABSTRACT

A photoconductor with a charge transport layer having about 20-25% by weight of 4-N,N-bis(4-methylphenyl)-amino-benzaldehyde-N′,N′-diphenylhydrazone is in an essentially standard resin binder, such as a polycarbonate resin binder. Electrical characteristics are those of the larger amounts using conventional charge transport agents, and the larger amount of binder provides much improved wear resistance and consequently longer useful life of the photoconductor. Charge transport layers with only the foregoing bis-methyl material do exhibit moderate fatigue upon exposure to light. However, this can be overcome by adding 0.5% or less of a fluorenyl-azine as a light absorber, specifically 9-(p-diethylaminobenzylidenehydrazono)fluorene, in the charge transport layer. No antioxidant is required for electrical stability improvement.

### TECHNICAL FIELD

The present invention relates to an improved photoconductor, used in electrophotographic imaging devices, having a charge transport layer providing long useful life of the photoconductor.

### BACKGROUND OF THE INVENTION

A good photoconductor should have adequate electrostatic characteristics and resistance to wear during use. Photoconductors typically have as primary elements a conductive substrate, a charge generation layer (CGL), and a charge transport layer (CTL) on the CGL. It is the outer CTL which is subject to mechanical friction and thereby is subject to wear. Frictional engagement typically is with toner, doctor blade, cleaning blades, and, in some applications, directly with a developer roller.

In the prior art the selection of materials of the CTL necessarily has somewhat defined the resistance to wear of the photoconductor, but resistance to wear had not been as desired. A need exists for increased resistance to wear in photoconductors.

This invention employs a charge generation material of the hydrazone class in the CTL and preferably employs a small amount of 9-(p-diethylaminobenzylidenehydrazono)fluorene to mitigate light fatigue. Such a combination is the subject of U.S. Pat. No. 6,432,597 B1 to Haggquist, which is commonly owned with this invention.

### SUMMARY OF THE INVENTION

This invention employs a CTL having the bis-methyl substituted form of a known charge transport material in much smaller proportion to the binder resin than has been employed. Specifically, as low as about 20-25% by weight of 4-N,N-bis(4-methylphenyl)-amino-benzaldehyde-N′,N′-diphenylhydrazone is in an essentially standard resin binder, such as a polycarbonate resin binder. Electrical characteristics are those of the larger amounts using conventional charge transport agents, and the larger amount of binder provides much improved wear resistance and consequently longer useful life of the photoconductor.

CTL's with only the foregoing bis-methyl material exhibit moderate fatigue upon exposure to light. However, this can be overcome by adding a minor amount of a fluorenyl-azine as a light absorber in the charge transport layer, specifically 0.5% or less by weight of the total weight of the CTL of 9-(p-diethylaminobenzylidenehydrazono)fluorene. No antioxidant is required for electrical stability improvement for this material, whereas oxidation has significant impact on the electrical stability of DEH-(a standard charge transport material)-containing formulations. (Standard photoconductors with DEH do employ an antioxidant.) An 80 to 90% increase in life is seen as compared with a photoconductor of similar sensitivity containing DEH.

### DESCRIPTION OF THE PREFERRED EMBODIMENTS

The structure and nomenclature of molecules employed in the description of this invention are as follows: The antioxidant is illustrative of a material used with DEH, but not required for this invention.

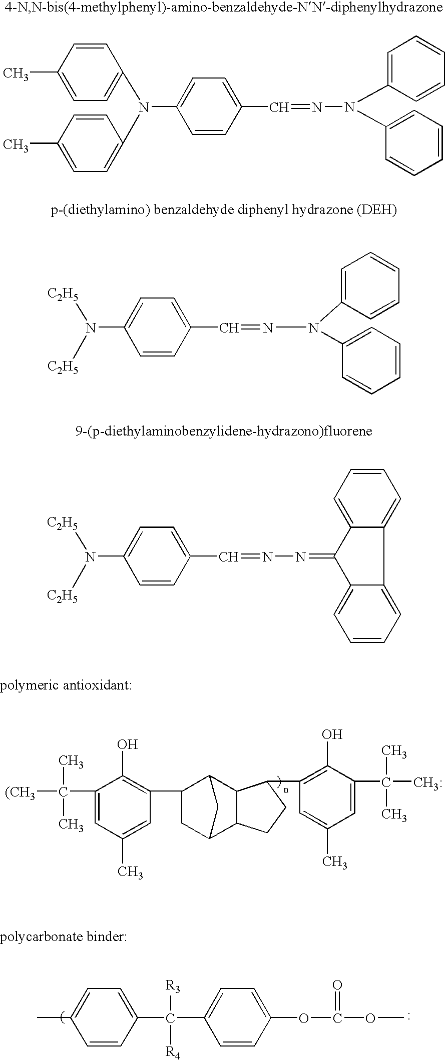

Where R3, R4=methyl, cyclohexyl or substituted cyclohexyl groups

The photoconductor consists of a conductive substrate, which is an anodized and sealed aluminum core, a charge generation layer, and a charge transport layer. The charge generation layer typically is comprised of a pigment, which is dispersed evenly in one or more types of binders before coating. The charge transport layer is comprised of one or more charge transport molecules and binder, with and without additives.

In the examples and throughout the present specification, parts and percentages are by weight.

### EXAMPLES

### Example A

Charge Generation Layer:

CG dispersion consists of titanyl phthalocyanine (type IV), and polyvinylbutyral (BX-1, Sekisui Chemical Co.) at a ratio of 67/33 in a mixture of 2-butanone and cyclohexanone. The CG dispersion was dip-coated on the aluminum substrate and dried at 100° C. for 15 minutes to give a thickness less than 1 μm, and more preferably, 0.2-0.3 μm.

Charge Transport Layer (22% 4-N,N-bis(4-methylphenyl)-amino-benzaldehyde-N′,N′-diphenyl-hydrazone):

A charge transport formulation containing 22% was prepared by dissolving 4-N,N-bis(4-methylphenyl)-amino-benzaldehyde-N′,N′-diphenylhydrazone (16.5 g), and polycarbonate A (58.5 g, MAKROLON 5208, Bayer Inc.) in a mixed solvent of tetrahydrofuran and 1,4-dioxane. The charge transport layer was coated on top of the charge generation layer and cured at 100° C. for 1 hour to give a thickness of 25-27 μm.

### Example B

Charge Generation Layer:

CG dispersion consists of titanyl phthalocyanine (type IV), polyvinylbutyral (Sekisui Chemical Co.), polyhydroxystyrene and poly(methyl-phenyl)siloxane in a ratio of 45/27.5/24.75/2.75 in a mixture of 2-butanone and cyclohexanone. The CG dispersion was dip-coated on aluminum substrate and dried at 100° C. for 15 minutes to give a thickness less than 1 μm, and more preferably, 0.2-0.3 μm.

Charge Transport Layer (22% 4-N,N-bis(4-methylphenyl)-amino-benzaldehyde-N′,N′-diphenylhydrazone:

Same as Example A

### Example C

Charge Generation Layer:

Same as in Example A

Charge Transport Layer (22% 4-N,N-bis(4-methylphenyl)-amino-benzaldehyde-N′,N′-diphenylhydrazone and 1.0% 9-(p-diethylaminobenzylidene-hydrazono)fluorene:

A charge transport formulation containing 22% was prepared by dissolving 4-N,N-bis(4-methylphenyl)-amino-benzaldehyde-N′,N′-diphenylhydrazone (16.5 g), 9-(p-diethylaminobenzylidene-hydrazono)fluorene (0.7 g) and polycarbonate A (57.7 g, MAKROLON 5208, Bayer Inc.) in a mixed solvent of tetrahydrofuran and 1,4-dioxane. The charge transport layer was coated on top of the charge generation layer and cured at 100° C. for 1 hour to give a thickness of 25-27 μm.

### Example D

Charge Generation Layer:

Same as in Example A L

Charge Transport layer (22% 4-N,N-bis(4-methylphenyl)-amino-benzaldehyde-N′,N′-diphenylhydrazone and 0.5% 9-(p-diethylaminobenzylidene-hydrazono)fluorene:

A charge transport formulation containing 22% was prepared by dissolving 4-N,N-bis(4-methylphenyl)-amino-benzaldehyde-N′,N′-diphenylhydrazone (19.8 g), 9-(p-diethylaminobenzylidene-hydrazono)fluorene (0.45 g) and polycarbonate A (69.1 g, MAKROLON 5208, Bayer Inc.) in a mixed solvent of tetrahydrofuran and 1,4-dioxane. The charge transport layer was coated on top of the charge generation layer and cured at 100° C. for 1 hour to give a thickness of 25-27 μm.

### Example E

Charge Generation Layer:

Same as in Example B.

Charge Transport Layer (22% 4-N,N-bis(4-methylphenyl)-amino-benzaldehyde-N′,N′-diphenylhydrazone and 0.1% 9-(p-diethylaminobenzylidene-hydrazono)fluorene:

A charge transport formulation containing 22% was prepared by dissolving 4-N,N-bis(4-methylphenyl)-amino-benzaldehyde-N′,N′-diphenylhydrazone (19.78 g), 9-(p-diethylaminobenzylidene-hydrazono)fluorene (0.09 g) and polycarbonate A (70.1 g, MAKROLON 5208, Bayer Inc.) in a mixed solvent of tetrahydrofuran and 1,4-dioxane. The charge transport layer was coated on top of the charge generation layer and cured at 100° C. for 1 hour to give a thickness of 25-27 μm.

### Example F

Charge Generation Layer:

Same as in Example B.

Charge Transport Layer (22% 4-N,N-bis(4-methylphenyl)-amino-benzaldehyde-N′,N′-diphenylhydrazone and 0.2% 9-(p-diethylaminobenzylidene-hydrazono)fluorene:

A charge transport formulation containing 22% was prepared by dissolving 4-N,N-bis(4-methylphenyl)-amino-benzaldehyde-N′,N′-diphenylhydrazone (19.78 g), 9-(p-diethylaminobenzylidene-hydrazono)fluorene (0.18 g) and 20 polycarbonate A (70.0 g, MAKROLON 5208, Bayer Inc.) in a mixed solvent of tetrahydrofuran and 1,4-dioxane. The charge transport layer was coated on top of the charge generation layer and cured at 100° C. for 1 hour to give a thickness of 25-27 μm.

### Example G

Charge Generation Layer:

Same as in Example B.

Charge Transport Layer (22% 4-N,N-bis(4-methylphenyl)-amino-benzaldehyde-N′,N′-diphenylhydrazone and 0.4% 9-(p-diethylaminobenzylidene-hydrazono)fluorine):

A charge transport formulation containing 22% was prepared by dissolving 4-N,N-bis(4-methylphenyl)-amino-benzaldehyde-N′,N′-diphenylhydrazone (19.78 g), 9-(p-diethylaminobenzylidenehydrazono)fluorene (0.36 g) and polycarbonate A (69.78 g, MAKROLON 5208, Bayer Inc.) in a mixed solvent of tetrahydrofuran and 1,4-dioxane. The charge transport layer was coated on top of the charge generation layer and cured at 100° C. for 1 hour to give a thickness of 25-27 μm.

### Example H

Charge Generation Layer:

Same as in Example B.

Charge Transport Layer (22% 4-N,N-bis(4-methylphenyl)-amino-benzaldehyde-N′,N′-diphenylhydrazone and 0.5% 9-(p-diethylaminobenzylidene-hydrazono)fluorene:

A charge transport formulation containing 22% was prepared by dissolving 4-N,N-bis(4-methylphenyl)-amino-benzaldehyde-N′,N′-diphenylhydrazone (17.98 g), 9-(p-diethylaminobenzylidene-hydrazono)fluorene (0.41 g) and polycarbonate A (63.33 g, MAKROLON 5208, Bayer Inc.) in a mixed solvent of tetrahydrofuran and 1,4-dioxane. The charge transport layer was coated on top of the charge generation layer and cured at 100° C. for 1 hour to give a thickness of 25-27 μm.

### Example I

Charge Generation Layer:

Same as in Example B.

Charge Transport Layer (22% 4-N,N-bis(4-methylphenyl)-amino-benzaldehyde-N′,N′-diphenylhydrazone and 1.0% 9-(p-diethylaminobenzylidene-hydrazono)fluorene):

A charge transport formulation containing 22% was prepared by dissolving 4-N,N-bis(4-methylphenyl)-amino-benzaldehyde-N′,N′-diphenylhydrazone (17.98 g), 9-(p-diethylaminobenzylidene-hydrazono)fluorene (0.82 g) and polycarbonate A (62.92 g, MAKROLON 5208, Bayer Inc.) in a mixed solvent of tetrahydrofuran and 1,4-dioxane. The charge transport layer was coated on top of the charge generation layer and cured at 100° C. for 1 hour to give a thickness of 25-27 μm.

### Example J

Charge Generation Layer:

Same as in Example B.

Charge Transport Layer (22% 4-N,N-bis(4-methylphenyl)-amino-benzaldehyde-N′,N′-diphenylhydrazone and 0.75% 9-(p-diethylaminobenzylidene-hydrazono)fluorene):

The CT solution consists of 50% CT from Example H and 50% from Example I.

The charge transport layer was coated on top of the charge generation layer and cured at 100° C. for 1 hour to give a thickness of 25-27 μm.

### Example K

Charge Generation Layer:

Same as in Example A.

Charge Transport Layer (20% 4-N,N-bis(4-methylphenyl)-amino-benzaldehyde-N′,N′-diphenylhydrazone:

A charge transport formulation containing 20% was prepared by dissolving 4-N,N-bis(4-methylphenyl)-amino-benzaldehyde-N,N-diphenylhydrazone (15.0 g), and polycarbonate A (60 g, MAKROLON 5208, Bayer Inc.) in a mixed solvent of tetrahydrofuran and 1,4-dioxane. The charge transport layer was coated on top of the charge generation layer and cured at 100° C. for 1 hour to give a thickness of 25-27 μm.

### Example L

Charge Generation layer:

Same as in Example A.

Charge Transport Layer (25% 4-N,N-bis(4-methylphenyl)-amino-benzaldehyde-N,N-diphenylhydrazone):

A charge transport formulation containing 25% was prepared by dissolving 4-N,N-bis(4-methylphenyl)-amino-benzaldehyde-N,N-diphenylhydrazone (25.0 g) and polycarbonate A (75 g, MAKROLON 5208, Bayer Inc.) in a mixed solvent of tetrahydrofuran and 1,4-dioxane. The charge transport layer was coated on top of the charge generation layer and cured at 100° C. for 1 hour to give a thickness of 25-27 μm.

### Example M

Charge Generation Layer:

Same as in Example A.

Charge Transport Layer (25% 4-N,N-bis(4-methylphenyl)-amino-benzaldehyde-N,N-diphenylhydrazone with 12% dioctyl terephthalate):

A charge transport formulation containing 25% was prepared by dissolving 4-N,N-bis(4-methylphenyl)-amino-benzaldehyde-N,N-diphenylhydrazone (25.0 g), dioctyl terephthalate (12.0 g, Aldrich) and polycarbonate A (63.0 g, MAKROLON 5208, Bayer Inc.) in a mixed solvent of tetrahydrofuran and 1,4-dioxane. The charge transport layer was coated on top of the charge generation layer and cured at 100° C. for 1 hour to give a thickness of 25-27 μm.

### Example N

Charge Generation Layer:

Same as in Example A.

Charge Transport Layer (40% 4-N,N-bis(4-methylphenyl)-amino-benzaldehyde-N,N-diphenylhydrazone):

A charge transport formulation containing 40% was prepared by dissolving 4-N,N-bis(4-methylphenyl)-amino-benzaldehyde-N,N-diphenylhydrazone (50 g), and polycarbonate A (75 MAKROLON 5208, Bayer Inc.) in a mixed solvent of tetrahydrofuran and 1,4-dioxane. The charge transport layer was coated on top of the charge generation layer and cured at 100-120° C. for 1 hour to give a thickness of 25-27 μm.

### Comparative Example A

Charge Generation Layer:

Same as in Example B.

Charge Transport Layer:

A charge transport formulation containing 38% DEH was prepared by dissolving 38% of DEH (30.7 g), 1% of Acetosol Yellow (0.8 g), 1% of polymeric antioxidant (0.8 g, Goodyear), and polycarbonate A (49.3 g, MAKROLON 5208, Bayer Inc.) in a mixed solvent of tetrahydrofuran and 1,4-dioxane. The charge transport layer was coated on top of the charge generation layer and cured at 100° C. for 1 hour to give a thickness of 24-27 μm.

Off-Line Electrical Evaluation:

Photo Induced Discharge:

The electrical charge, discharge, and dark decay characteristics were determined initially for the Example A, Comparative Example A, and Example B formulations for discharge voltage as a function of energy at expose-to-develop time of 97 ms. Initial voltage was about −800 volts. At about 0.1 microjoule per cm squared (μJ/cm²) discharge energy, Example A discharged to about −265 volts, Comparative Example A discharged to about −390 volts, and Example B discharged to about −345 volts. At about 0.2 μJ/cm² discharge energy, Example A discharged to about −200 volts, Comparative Example A discharged to about −220 volts, and Example B discharged to about −230 volts. Example A did not show significant additional discharge with additional discharge energy; Comparative Example A reached −200 volts at about 0.23 μJ/cm discharge energy and then did not show significant further discharge with additional discharge energy; and Example B did not show significant further discharge with additional discharge energy. This demonstrates that sensitivity is actually improved by this invention.

Life in Printer Evaluation:

All wear data reported here is from testing in Lexmark OPTRA T634, 40 page-per-minute printers, with run mode of duplex, 4-page and pause. End of test point is determined by the on-set of background failure, typically appearing first in the paper edge area. The thickness of charge transport layer was determined at the beginning and the end of test. Wear rate is then calculated through dividing the change in thickness by the number of prints (in thousands).

As can be seen from Table 1, the drums prepared in example A almost double the life in printer as compared to the reference drums.

TABLE 1
Wear performance in printer:

| | Average | Thickness, um | | | |
|---|---|---|---|---|---|
| | Life, | Initial | Final | Wear Rate, um/K | |
| Example | prints | Min | Min | Avg | Max |
| Comperative example | 60,559 | 23.9 | 11.3 | 0.12 | 0.30 |
| A (n = 2) | | | | | |
| Example C (n = 4) | 109,269 | 22.6 | 9.1 | 0.06 | 0.12 |
| Example L (n = 2) | 95,027 | 26.5 | 9.7 | 0.095 | 0.19 |

Electrical Stability Evaluation:

The discharge in printer (OPTRA T, 30 PPM) was measured before and after 40K prints under various settings as shown in Table 2. Fatigue is defined as the discharge change between 40K and OK. As shown in the table below, the example A has more stability in terms of electrical discharge.

TABLE 2
Electrical fatigue properties over 40K prints:

| | All Black | All Black | Streak | Streak |
|---|---|---|---|---|
| Example | DS = 8 | DS = 3 | DS = 3 | DS = 8 |
| Comparative | 47 | −15 | −62 | −61 |
| example (n = 4) | | | | |
| Example A (n = 2) | 20 | −7 | −25 | −24 |
| Example B (n = 2) | 13 | −3 | −18 | −18 |
| Example C (n = 2) | 7 | −26 | −54 | −53 |

As demonstrated in Table 2, the modified formulations have reduced fatigue over life as compared to the standard formulation with DEH.
Room Light Fatigue Test:
a. Off-Line

Drums from Example B, E-J were evaluated for room light fatigue properties. The photo-induced-discharge properties were measured before any light exposure. Then, the same measurement was done immediately after the drums were exposed to indoors room light for 2 hours (equivalent to 936 μJ/cm²) in a robot in which a drum is rotated at a constant speed. The discharges were charted together. As can be seen from the chart below, without any 9-(p-diethylaminobenzylidene-hydrazono)fluorene, the discharge is increased by about 90V after the light exposure while 70V increase is seen with 0.1% of the room-light-fatigue reducer. This fatigue decreases as the loading of 9-(p-diethylaminobenzylidene-hydrazono)fluorene) increases, and 0.5% loading of the compound eliminates light-induced fatigue completely. No additional benefit is seen with loading higher than 0.5% in current tests.

TABLE 3
Off-line room-light-fatigue: residual voltage shift
before and after exposure (50 PPM, 49 ms)

| | Comparative | | | | | | | |
|---|---|---|---|---|---|---|---|---|
| Example | A | B | E | F | G | H | J | I |
| %9-(p-dethylamino- | | 0 | 0.1 | 0.2 | 0.4 | 0.5 | 0.75 | 1 |
| benzylidene- | | | | | | | | |
| hydrazono)fluorene | | | | | | | | |
| Fatigue (Vpost light | −45 | −89 | −65 | −45 | −14 | −1 | 2 | 6 |
| exposure-Vo) | | | | | | | | |

b. Printer

The following drums were exposed to fluorescent light from a desk overhead lamp, 40 cm distant, for 1 hour. The drums were then tested in 5% continuous mode; PQ was taken every 1 K prints, and the test was ended at 8K.

TABLE 4
Room light fatigue test in printer

| | | Light Gray | Dark Gray | |
|---|---|---|---|---|
| Example | Gray page | Page | Page | Black Page |
| Example A | F | F | F | F |
| Example D | NRF | NRF | NRF | NRF |

F = Room Light Fatigue @ each PQ point
NRF = No Room Light Fatigue

The data in Table 4 indicates that the room light fatigue can become a potential issue with this charge transport material in the absence of room-light-fatigue agent. However, this issue of print defect can be readily fixed by formulating small amounts of light absorber, e.g. 0.5% of 9-(p-diethyl-aminobenzylidene-hydrazono)fluorene into the charge transport layer.

A wide range of photoconductor formulations will be consistent with this invention so long as the charge transport layer uses a relatively small amount of 4-N,N-bis(4-methylphenyl)-amino-benzaldehyde-N′,N′-diphenylhydrazone.

What is claimed is:

1. a photoconductor having an outer, charge transport layer, said charge: transport layer comprising about 20-25% by weight of 4-N,N-bis(4-methylphenyl)-amino-benzaldehyde-N′,N′-diphenylhydrazone in a resin binder.

2. The photoconductor as in claim 1 also comprising in said charge transport layer a fluorenyl-azine as a light absorber.

3. The photoconductor as in claim 1 in which said binder comprises polycarbonate resin.

4. The photoconductor as in claim 2 in which said binder comprises polycarbonate.

5. The photoconductor as in claim 2 in which said fluorenyl-azine is 9-(p-diethylaminobenzylidenehydrazono)fluorene.

6. The photoconductor as in claim 4 in which said fluorenyl-azine is 9-(p-diethylaminobenzylidenehydrazono)fluorene.

7. The photoconductor as in claim 2 in which said fluorenyl-azine is in amount of about 0.5 percent by weight of the weight of said charge transport layer.

8. The photoconductor as in claim 4 in which said fluorenyl-azine is in amount of about 0.5 percent by weight of the weight of said charge transport layer.

9. The photoconductor as in claim 5 in which said fluorenyl-azine is in amount of about 0.5 percent by weight of the weight of said charge transport layer.

10. The photoconductor as in claim 6 in which said fluorenyl-azine is in amount of about 0.5 percent by weight of the weight of said charge transport layer.
